(19) United States
(12) Patent Application Publication
(10) Pub. No.: US 2008/0116783 A1
(43) Pub. Date: May 22, 2008

(54) ELECTRON EMISSION DEVICE AND ELECTRON EMISSION DISPLAY USING THE ELECTRON EMISSION DEVICE

(76) Inventors: Il-Hwan Kim, Yongin-si (KR); Kyu-Won Jung, Yongin-si (KR)

Correspondence Address: CHRISTIE, PARKER & HALE, LLP, PO BOX 7068, PASADENA, CA, 91109-7068, US

(21) Appl. No.: 11/842,894

(22) Filed: Aug. 21, 2007

(30) Foreign Application Priority Data
Nov. 17, 2006 (KR) 10-2006-0114079

(51) Int. Cl. H01J 1/62

(52) U.S. Cl. 313/498

(57) ABSTRACT

An electron emission device, a method of manufacturing the electron emission device, and an electron emission display having the electron emission device are provided. The electron emission device includes: a first substrate; at least one sub-electrode in the first substrate; at least one cathode electrode, the at least one cathode electrode being on the first substrate and substantially covering the sub-electrode; at least one electron emission region on the cathode electrode; a first insulation layer, the first insulation layer being on the first substrate, substantially covering the cathode electrode and having at least one opening corresponding to the electron emission region; and at least one gate electrode, the at least one gate electrode being on the first insulation layer and having at least one opening corresponding to the electron emission region.

### CROSS-REFERENCE TO RELATED APPLICATION

This application claims priority to and the benefit of Korean Patent Application No. 10-2006-0114079 filed on Nov. 17, 2006 in the Korean Intellectual Property Office, the entire content of which is incorporated herein by reference.

### BACKGROUND OF THE INVENTION

1. Field of the Invention

The present invention relates to an electron emission device, and an electron emission display using the electron emission device.

2. Description of the Related Art

Generally, an electron emission element includes cathode and gate electrodes functioning as driving electrodes for controlling an electron emission of an electron emission region.

For example, the electron emission element includes a cathode electrode and a gate electrode crossing the cathode electrode with an insulation layer interposed between the cathode and gate electrodes. Openings are formed in the gate electrodes and the insulation layer at a crossing region of the cathode and gate electrode. An electron emission region is formed on the cathode electrode in the openings. When voltages are applied to the cathode and gate electrodes, electrons are emitted from the electron emission region.

A plurality of electron emission elements may be arrayed on a first substrate to form an electron emission device. With this configuration, one of the cathode and gate electrodes is applied with a scan signal voltage and the other is applied with a data signal voltage. Therefore, an electric field is formed around an electron emission region of an electron emission element where a voltage difference between the cathode and gate electrodes is equal to or greater than a threshold value and thus the electrons are emitted from the electron emission region.

A light emission unit having a phosphor layer, a black layer, and an anode electrode is formed on a surface of a second substrate opposite to the first substrate. The combination of the first and second substrates forms an electron emission display.

In the electron emission display, the cathode electrodes are formed of a transparent conductive material such as indium tin oxide (ITO), and are arranged in a line pattern on the first substrate.

The cathode electrodes formed of the transparent conductive material have a relatively high resistance. Therefore, an increase in a length of the cathode electrodes due to increases in the size of the electron emission display may result in the generation of a voltage-drop during the driving of the electron emission device. As a result, the light emission uniformity along the length of the cathode electrodes may be deteriorated and thus there may be a luminance difference between pixels throughout the screen, thereby reducing a display quality of the electron emission display.

To address the above problems, each of the cathode electrodes may include a transparent conductive layer formed of ITO and a sub-electrode layer formed on the transparent conductive layer. In order to address the resistance problem of the transparent conductive layer, in some embodiments, the sub-electrode layer is formed of a metal having a high level of electric conductivity, such as silver or chrome.

In the electron emission device, the sub-electrode layer is formed on the transparent conductive layer and the insulation layer is formed on the sub-electrode layer. In addition, the gate electrode is formed on the insulation layer.

The sub-electrode layer, however, is designed to easily diffuse a material thereof to the insulation layer during a firing process of the insulation layer.

If the material of the sub-electrode layer is diffused to the insulation layer, the performance of the insulation layer is deteriorated and thus it is difficult to provide a stable voltage property between the cathode electrodes and gate electrodes. As a result, a short circuit may develop between the sub-electrode layer and the gate electrode.

In addition, when the sub-electrode layer is formed on the transparent conductive layer, it is elevated from a surface of the transparent conductive layer. Therefore, a step coverage problem where the surface of the insulation layer is uneven may occur.

### SUMMARY OF THE INVENTION

The present invention provides embodiments of an electron emission device having cathode electrodes that meet high-quality standards while not adversely affecting the insulation layer during a manufacturing process.

The present invention also provides embodiments of an electron emission device that can improve the step coverage problem of an insulation layer. The present invention also provides embodiments of an electron emission display having the electron emission device.

In one embodiment of the present invention, an electron emission device is provided. The electron emission device includes: a first substrate; at least one sub-electrode in the first substrate; at least one cathode electrode on the first substrate and covering the at least one sub-electrode; at least one electron emission region on the at least one cathode electrode; a first insulation layer on the first substrate, the first insulation layer covering the at least one cathode electrode and having at least one opening corresponding to the at least one electron emission region; and at least one gate electrode on the first insulation layer and having at least one opening corresponding to the at least one electron emission region.

In some embodiments, the at least one sub-electrode is positioned in a groove on the first substrate. In some embodiments, the first substrate includes a transparent material and the cathode electrode includes a transparent conductive material. In various embodiments, the at least one sub-electrode is spaced from the at least one electron emission region. In various embodiments, the at least one sub-electrode includes a pair of sub-electrodes, and a corresponding one of the at least one electron emission region is located between the pair of sub-electrodes. In various embodiments, the pair of sub-electrodes are symmetrically arranged with respect to the corresponding one of the at least one electron emission region. In some embodiments, the at least one sub-electrode is adjacent the cathode electrode at only one side of the at least one electron emission region.

In some embodiments, a surface of the first substrate and a surface of the sub-electrode are coplanar. In some embodiments, the electron emission device further includes: a second insulation layer positioned on the gate electrode; and a focusing electrode positioned on the second insulation layer. In some embodiments, the at least one sub-electrode includes metal.

In one embodiment of the present invention, an electron emission display is provided. The electron emission display includes an electron emission device. The electron emission device includes: a first substrate; at least one sub-electrode in the first substrate; at least one cathode electrode on the first substrate and covering the at least one sub-electrode; at least one electron emission region on the at least one cathode electrode; a first insulation layer on the first substrate, the first insulation layer covering the at least one cathode electrode and having at least one opening corresponding to the at least one electron emission region; and at least one gate electrode on the first insulation layer and having at least one opening corresponding to the at least one electron emission region. The display also includes: a second substrate facing the first substrate at a selected distance from the first substrate; and a light emission unit positioned on the second substrate.

In some embodiments, the at least one sub-electrode is positioned in a groove on the first substrate. In some embodiments, the first substrate includes a transparent material and the cathode electrode includes a transparent conductive material. In various embodiments, the at least one sub-electrode is spaced from the at least one electron emission region. In various embodiments, the at least one sub-electrode includes a pair of sub-electrodes, and a corresponding one of the at least one electron emission region is located between the pair of sub-electrodes. In various embodiments, the pair of sub-electrodes are symmetrically arranged with respect to the corresponding one of the at least one electron emission region. In some embodiments, the at least one sub-electrode is adjacent the cathode electrode at only one side of the at least one electron emission region.

In some embodiments, a surface of the first substrate and a surface of the sub-electrode are coplanar. In some embodiments, the electron emission device further includes: a second insulation layer positioned on the gate electrode; and a focusing electrode positioned on the second insulation layer. In some embodiments, the at least one sub-electrode includes metal.

### BRIEF DESCRIPTION OF THE DRAWINGS

A more complete appreciation of the present invention will be readily apparent as the present invention becomes better understood by reference to the following detailed description when considered in conjunction with the accompanying drawings in which like reference symbols indicate the same or similar components, wherein:

FIG. 1 is a partially exploded perspective view of an electron emission display according to an exemplary embodiment of the present invention;

FIG. 2 is a partial sectional view of the electron emission display taken along the line II-II of FIG. 1;

FIG. 3 is a partial sectional view of an electron emission display according to another exemplary embodiment of the present invention;

FIG. 4 is a partial sectional view of an electron emission display according to another exemplary embodiment of the present invention; and

FIGS. 5A, 5B, 5C, 5D, 5E, 5F, 5G, 5H and 5I are sectional views illustrating a sequential process in a method of manufacturing an electron emission device applied to the electron emission display of FIGS. 1 and 2 according to an exemplary embodiment of the present invention.

### DETAILED DESCRIPTION

The present invention will now be described more fully with reference to the accompanying drawings, in which embodiments of the invention are shown. The invention may, however, be embodied in many different forms and should not be construed as being limited to the embodiments set forth herein; rather these embodiments are provided so that this disclosure will be thorough and complete, and will fully convey the concept of the invention to those skilled in the art.

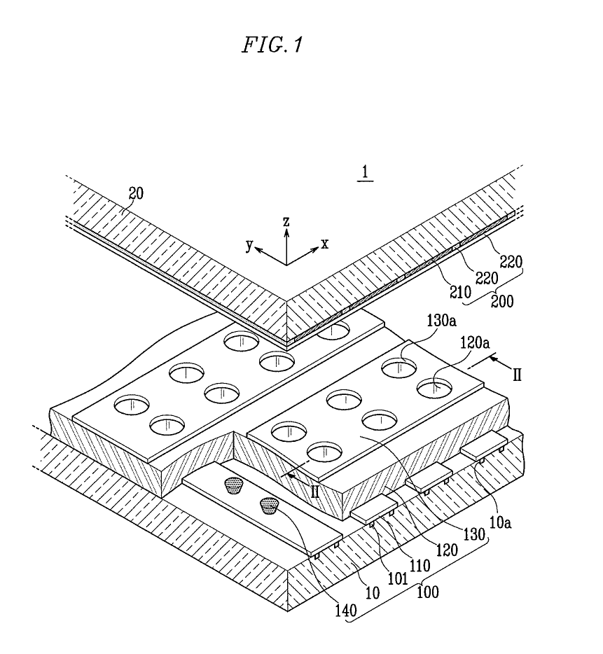

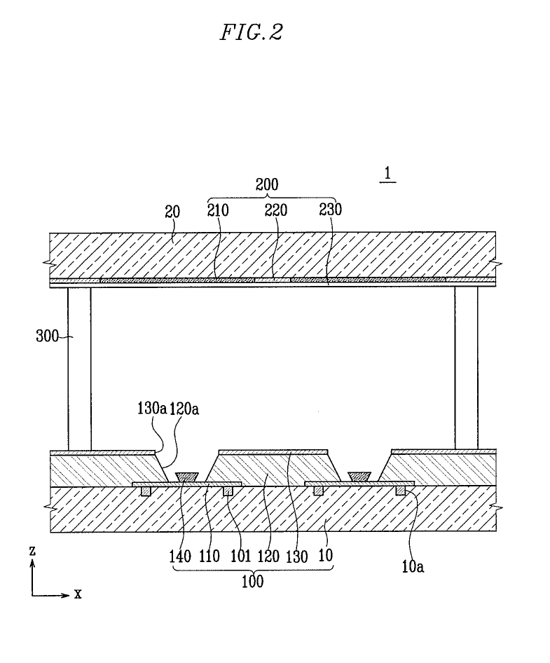

FIG. 1 is a partially exploded perspective view of an electron emission display according to an embodiment of the present invention, and FIG. 2 is a partial sectional view of the electron emission display taken along the line II-II of FIG. 1.

Referring to FIGS. 1 and 2, an electron emission display 1 includes an electron emission device 100 having a plurality of electron emission elements arrayed on an inner surface of a first substrate 10, and a light emission unit 200 formed on an inner surface of a second substrate 20.

A sealing member (not shown) is provided at the peripheries of the first substrate 10 and second substrate 20 to seal them together, thereby forming a vacuum vessel.

The electron emission device 100 further includes sub-electrodes 101, cathode electrodes 110, a first insulation layer 120, gate electrodes 130, and electron emission regions 140.

The first substrate 10 may be formed of a transparent material such as glass so that the electron emission regions 140 can be formed of, for example, carbon nanotube (CNT) paste through a backside-exposure process.

The sub-electrodes 101 are inserted in grooves 10a formed in the first substrate 10. For example, the sub-electrodes 101 are arranged in a stripe pattern extending in a first direction (a y-axis) of the first substrate 10. The sub-electrodes 101 function to reduce the likelihood of distortion of an input signal by compensating for a resistivity of the cathode electrodes 110. Therefore, the sub-electrodes 101 may be formed of a material having a low resistivity, such as silver (Ag), aluminum (Al), chrome (Cr) or platinum (Pt). The top surfaces of the sub-electrodes 101 and the top surface of the first substrate 10 are coplanar to reduce the likelihood of deterioration in the step coverage of the first insulation layer 120 that will be formed in a subsequent process.

The grooves 10a for the sub-electrodes 101 are formed with a proper depth to correspond to the size of the sub-electrodes 101.

The cathode electrodes 110 are formed on the sub-electrodes 101. The cathode electrodes 110 are formed in a stripe pattern extending in the first direction of the first substrate 10. The cathode electrodes 110 are formed of a transparent conductive material such as indium tin oxide (ITO).

The first insulation layer 120 is formed on an entire surface of the first substrate while covering the cathode electrodes 110. The gate electrodes 130 are formed on the first insulation layer 120 in a stripe pattern extending in a direction intersecting the cathode electrodes 110.

Openings 130a and openings 120a are respectively formed in the gate electrodes 130 and the first insulation layer 120 at each crossing region (“unit pixel region”) of the cathode electrodes 110 and gate electrodes 130, thereby partly exposing the cathode electrodes 110.

The electron emission regions 140 are formed on exposed surfaces of the cathode electrodes 110. The electron emission regions 140 may be formed of a material that emits electrons when an electric field is applied thereto under a vacuum atmosphere, such as a carbonaceous material or a nanometer-sized material. For example, the electron emission regions 140 may be formed of carbon nanotubes, graphite, graphite nanofibers, diamonds, diamond-like carbon, fullerene C₆₀, silicon nanowires or a combination thereof.

In FIGS. 1 and 2, an embodiment wherein the electron emission regions 140 are circularly shaped and arranged along a length of the cathode electrode 110 is illustrated. However, the present invention is not limited in this regard. The shape, number, and arrangement of the electron emission regions per each unit pixel region may be variously changed in other embodiments.

In one embodiment, the gate electrodes 130 may be formed of a conductive material selected from the group consisting of gold (Au), silver (Ag), molybdenum (Mo), platinum (Pt), aluminum (Al), chrome (Cr), and an alloy thereof.

In the above-described electron emission display 1, one cathode electrode 110, one gate electrode 130, a portion of the first insulation layer 120 that is disposed at the crossing region of the cathode electrode 110 and gate electrode 130, and the electron emission regions 140 located at the crossing region form one electron emission element. That is, the electron emission device 100 includes a plurality of the electron emission elements arrayed on the first substrate 10.

In order to perform a backside exposure process (performed by irradiating light from an outer side to an inner side of the first substrate 10) for forming the electron emission regions 140, the sub-electrodes 101 may be spaced apart from the electron emission regions 140. For example, the sub-electrodes 101 may be symmetrically arranged along both side edges of each of the cathode electrodes 110 with the electron emission regions 140 arranged between them. That is, two or more sub-electrodes 101 are arranged along both side edges of each cathode electrode 110 with the electron emission regions 140 arranged between them.

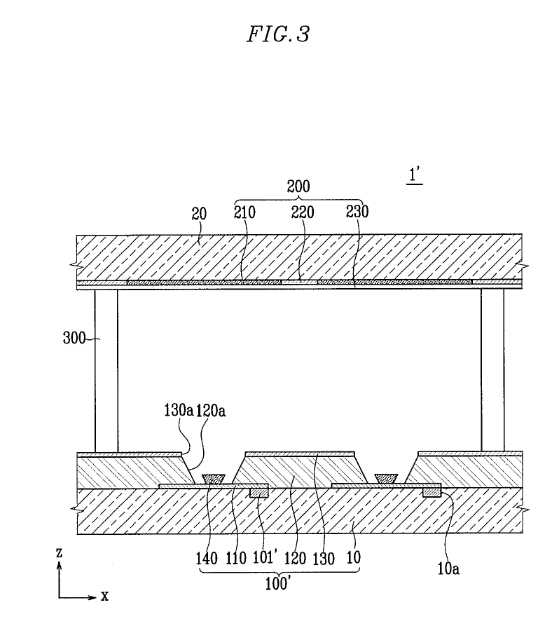

In some embodiments, as shown in an electron emission display 1′ of FIG. 3, a sub electrode 101′ is formed along only one side edge of each cathode electrode 110.

Therefore, when the backside exposure process is performed to form the electron emission regions 140, the portions where the electron emission regions 140 will be formed are not blocked by the sub-electrodes 101′ since the sub-electrodes are spaced apart from the electron emission regions 140.

The light emission unit 200 includes phosphor layers 210 formed on an inner surface of the second substrate 20, a black layer 220 formed between the phosphor layers 210, and an anode electrode 230 formed on surfaces of the phosphor layers 210 and the black layer 220.

The anode electrode 230, which is a metal layer formed of, for example, aluminum, is formed on the phosphor layers 210. The anode electrode 230 functions to place the phosphor layers 210 in a high potential state by receiving a voltage required for accelerating the electron beams and to enhance the screen luminance by reflecting the visible light radiated from the phosphor layers 210 to the first substrate 10 toward the second substrate 20.

In some embodiments, the anode electrode may be a transparent conductive layer formed of, for example, indium tin oxide (ITO). In this case, the anode electrode is located between the second substrate 20 and the phosphor layers 210.

In some embodiments, the anode electrode may include both the transparent conductive layer and the metal layer.

The phosphor layers 210 may be formed to correspond to the respective unit pixel regions or formed in a stripe pattern extending in a vertical direction (a y-axis) of the screen. The black layer 220 may be formed of a non-transparent material such as chrome or chrome oxide.

In the present exemplary embodiment, the phosphor layers 210 are formed to correspond to the respective electron emission elements. With this configuration, one phosphor layer 210 and the corresponding electron emission element substantially define one pixel.

Disposed between the first substrate 10 and second substrate 20 are spacers 300 for uniformly maintaining a gap between the first substrate 10 and second substrate 20, even when an external force is applied to the first substrate 10 and second substrate 20. The spacers 300 are located corresponding to a location of the black layer 220 so as not to interfere with the light emission of the phosphor layers 210.

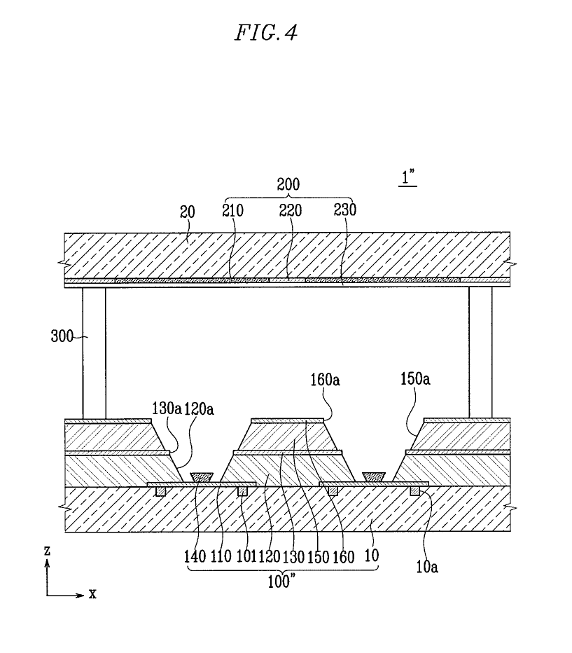

FIG. 4 is a partial sectional view of an electron emission display according to another embodiment of the present invention.

Referring to FIG. 4, an electron emission device 100″ includes a second insulation layer 150 covering the gate electrodes 130 and a focusing electrode 160 formed on the second insulation layer 150. Electron beam passing openings 150a and 160a are respectively formed in the second insulation layer 150 and the focusing electrode 160. The openings 150a and 160a are formed to correspond to the respective electron emission regions 140 to individually converge the electrons emitted from the electron emission regions 140. In some embodiments, the electron emission regions 140 are formed to correspond to the respective electron emission elements to generally converge the electrons emitted from the electron emission regions 140 of each electron emission element.

In FIGS. 1, 2, and 4, like reference symbols indicate like elements. Therefore, a detailed description of the like elements will be omitted herein.

The following will describe an operation of the electron emission display 1, 1′, 1″.

In one or more embodiments, one of the cathode electrodes 110 and gate electrodes 130 functions as a scan electrode for receiving a scan driving voltage and the other functions as a data electrode for receiving a data driving voltage. The anode electrode 230 receives a direct current voltage of, for example, hundreds to thousands of volts that can accelerate the electron beams.

Electric fields are formed around the electron emission regions 140 at the electron emission elements where a voltage difference between the cathode electrode 110 and gate electrode 130 is equal to or higher than a threshold value and thus the electrons are emitted from the electron emission regions 140. The emitted electrons strike the corresponding phosphor layers 210 by the high voltage applied to the anode electrode 230, thereby exciting the phosphor layers 210 to realize an image.

During the above procedure, the sub-electrodes 101 (101′ for the embodiment depicted in FIG. 3) compensate for a resistivity of the cathode electrodes 110 formed of ITO material, thereby preventing the distortion of an input signal.

The following will describe a method of manufacturing the above-described electron emission device of FIGS. 1 and 2.

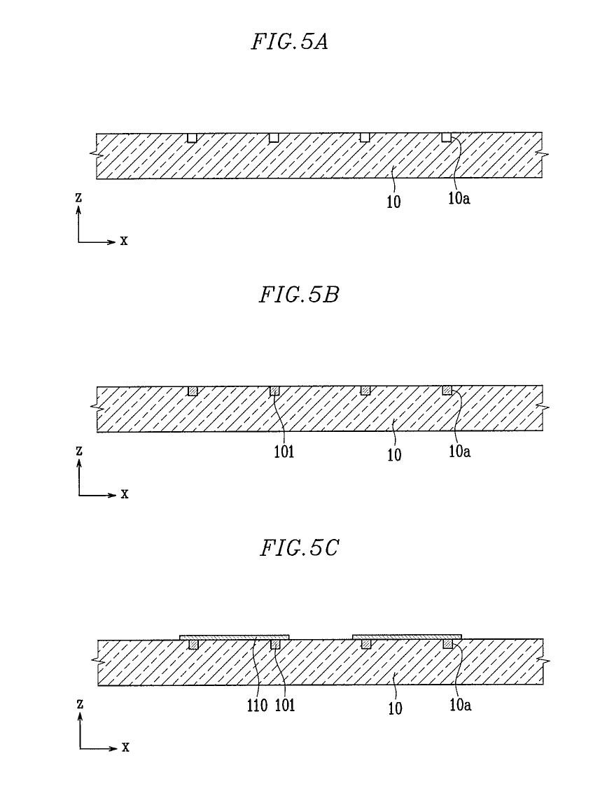

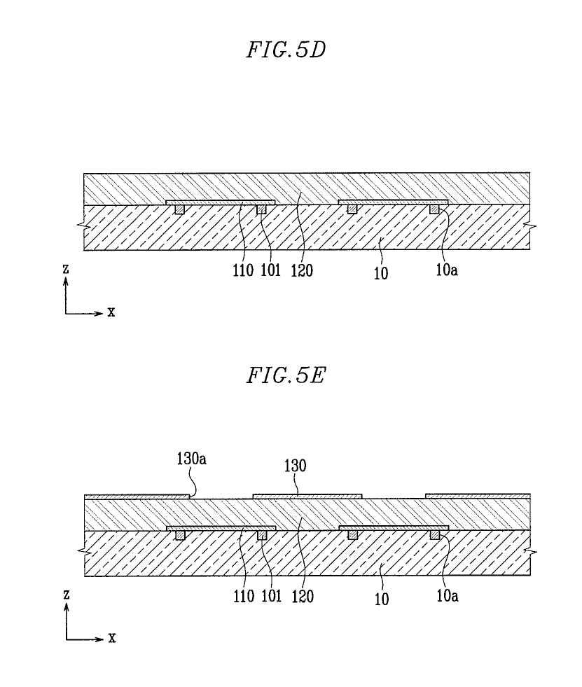

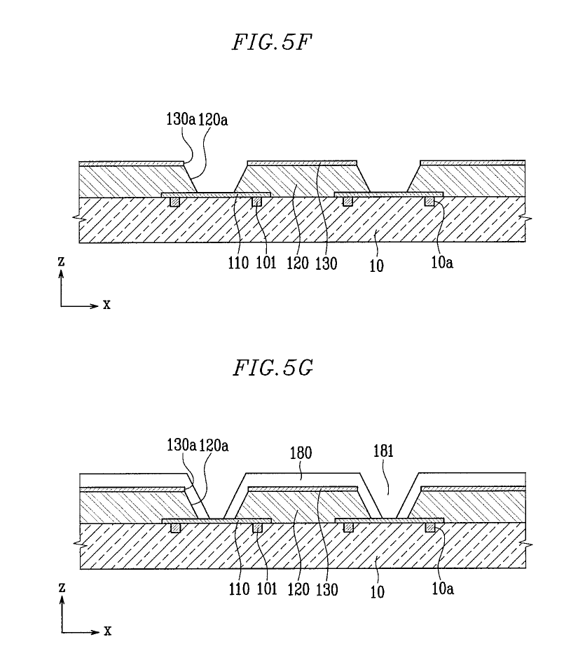

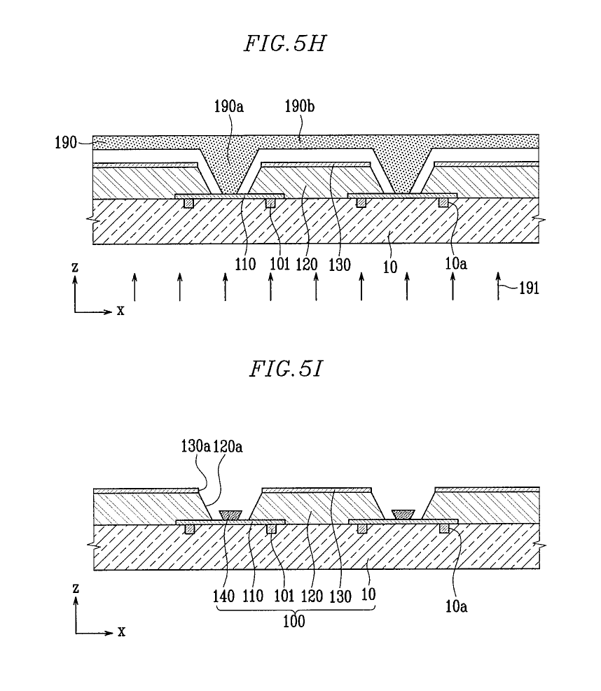

FIGS. 5A, 5B, 5C, 5D, 5E, 5F, 5G, 5H and 5I are sectional views illustrating a sequential process in a method of manufacturing an electron emission device applied to the electron emission display of FIGS. 1 and 2 according to an embodiment of the present invention.

Referring first to FIG. 5A, the grooves 10a for the sub-electrodes 101 are formed in the first substrate 10. The grooves 10a may be formed through a photolithography or laser etching process. The first substrate 10 may be formed of a transparent material to allow for a backside exposure process for forming the electron emission regions 140.

Referring to FIG. 5B, the sub-electrodes 101 are formed in the grooves 10a. The sub-electrodes 101 may be formed through a screen-printing or inkjet printing process using a material having a high level of conductivity, such as silver (Ag), aluminum (Al), chrome (Cr) or platinum (Pt).

The sub-electrodes 101 may be symmetrically formed on both side edges of each cathode electrode 110. In some embodiments, only one sub-electrode 101 may be formed along only one side edge of each of the cathode electrodes 110 (e.g., FIG. 3). The sub-electrodes 101 may be formed at any location spaced apart from the electron emission regions 140 as long as the sub-electrodes 101 do not block the light irradiated during the backside exposure process for forming the electron emission regions 140.

An additional process may be performed for making the surface of the first substrate 10 and the surfaces of the sub-electrodes 101 coplanar. By making these elements coplanar, a surface unevenness of the first insulation layer 120 that will be formed through a subsequent process can be prevented, thereby improving the step coverage.

Referring to FIG. 5C, a transparent conductive material such as ITO is deposited (e.g., at a predetermined thickness) and in a stripe pattern on the surfaces of the sub-electrodes 101 and the first substrate 10, thereby forming the cathode electrodes 110. Stripe patterning may be realized through a photolithography or etching process. As the cathode electrodes 110 are formed above the sub-electrodes 101, the diffusion of the sub-electrodes 101 into the first insulation layer 12 can be prevented during the firing process for the first insulation layer 120.

Referring to FIG. 5D, the first insulation layer 120 is formed (e.g., at a predetermined thickness) on the first substrate 10. When the first insulation layer 120 is formed through a thick film process, an insulation material in paste form is deposited (e.g., at a predetermined thickness) through a screen-printing process, after which a firing process is performed.

Referring to FIG. 5E, a highly conductive metallic material is deposited (e.g., at a predetermined thickness) on the first insulation layer 120 through a sputtering process. The metallic material may be selected from the group consisting of gold (Au), silver (Ag), molybdenum (Mo), platinum (Pt), aluminum (Al), chrome (Cr), and an alloy thereof. Subsequently, the openings 130a are formed in the resultant layer through photolithography and etching processes, thereby partly exposing the first insulation layer 120. The openings 130a are formed at each unit pixel region where the cathode electrode 110 and gate electrodes 130 cross.

Referring to FIG. 5F, portions of the first insulation layer 120 exposed by the openings 130a are etched through, for example, a wet-etching process, thereby partly exposing the cathode electrodes 110.

Referring to FIG. 5G, a photosensitive material such as a photoresist is deposited on exposed portions of the cathode electrodes 110 through the openings 130a and 120a to form a sacrifice layer 180 having an electron emission region pattern 181.

Referring to FIG. 5H, a photosensitive carbon nanotube paste 190 is deposited on the sacrifice layer 180 through a screen-printing process. Subsequently, ultraviolet rays 191 are irradiated toward a rear surface of the first substrate 10. At this point, due to the patterning of the sacrifice layer 180, only exposed portions 190a are exposed to the ultraviolet rays 191 and are thus hardened. By controlling an amount of the light exposure, the light exposure depth of the carbon nanotube paste can be adjusted. The carbon nanotube paste 190 has a negative polarity and has a property by which any portion exposed to light is not dissolved by a developing solution.

Referring to FIG. 5I, the sacrifice layer 180 is removed using a developing solution such as acetone. At this point, the unexposed portions 190b of the carbon nanotube layer 190 is removed together with the sacrifice layer 180. As a result, only the exposed portions 190a of the carbon nanotube layer 190 remain to form the electron emission regions 140.

When the firing process is performed, the electron emission regions 140 are baked and contracted to have a desired height. At this point, the firing temperature may be varied depending on the type and constituent components of the carbon nanotube paste 190.

The above-described embodiment includes an electron emission device having the cathode electrodes 110, the first insulation layer 120, the gate electrodes 130, and the electron emission regions 140. However, as shown in FIG. 4, a case where the focusing electrode 160 is formed above the gate electrodes 130 with the second insulation 150 interposed between the focusing electrode 160 and the gate electrodes 130 can be applied.

According to the present invention, since the sub-electrodes are inserted in the substrate and the cathode electrodes are formed on the substrate, the diffusion of the sub-electrodes to the insulation layer can be prevented during the firing process for the insulation layer. As a result, the insulation layer can be finely formed.

In addition, since the top surfaces of the sub-electrode and the surface of the substrate are coplanar, the step coverage of the first insulation layer can be improved.

Therefore, the display quality of the electron emission display can be improved.

Furthermore, when the present invention is applied to a light emission device, the luminance of the light emission device can be enhanced. Therefore, when the light emission device is applied to a display, the display quality can be improved.

Although exemplary embodiments of the present invention have been shown and described, it will be appreciated by those skilled in the art that changes may be made in this embodiment without departing from the principles and spirit of the invention, the scope of which is defined in the claims and their equivalents.

What is claimed is:

1. An electron emission device comprising:
a first substrate;
at least one sub-electrode in the first substrate;
at least one cathode electrode on the first substrate and covering the at least one sub-electrode;
at least one electron emission region on the at least one cathode electrode;
a first insulation layer on the first substrate, the first insulation layer covering the at least one cathode electrode and having at least one opening corresponding to the at least one electron emission region; and
at least one gate electrode on the first insulation layer and having at least one opening corresponding to the at least one electron emission region.

2. The electron emission device of claim 1, wherein the at least one sub-electrode is positioned in a groove on the first substrate.

3. The electron emission device of claim 1, wherein the first substrate comprises a transparent material and the cathode electrode comprises a transparent conductive material.

4. The electron emission device of claim 3, wherein the at least one sub-electrode is spaced from the at least one electron emission region.

5. The electron emission device of claim 4, wherein the at least one sub-electrode comprises a pair of sub-electrodes, and a corresponding one of the at least one electron emission region is located between the pair of sub-electrodes.

6. The electron emission device of claim 5, wherein the pair of sub-electrodes are symmetrically arranged with respect to the corresponding one of the at least one electron emission region.

7. The electron emission device of claim 4, wherein the at least one sub-electrode is adjacent the cathode electrode at only one side of the at least one electron emission region.

8. The electron emission device of claim 1, wherein a surface of the first substrate and a surface of the sub-electrode are coplanar.

9. The electron emission device of claim 1, further comprising:
a second insulation layer positioned on the gate electrode; and
a focusing electrode positioned on the second insulation layer.

10. The electron emission device of claim 1, wherein the at least one sub-electrode comprises metal.

11. An electron emission display comprising:
an electron emission device including:
a first substrate;
at least one sub-electrode in the first substrate;
at least one cathode electrode on the first substrate and covering the at least one sub-electrode;
at least one electron emission region on the at least one cathode electrode;
a first insulation layer on the first substrate, the first insulation layer covering the at least one cathode electrode and having at least one opening corresponding to the at least one electron emission region; and
at least one gate electrode on the first insulation layer and having at least one opening corresponding to the at least one electron emission region;
a second substrate facing the first substrate at a selected distance from the first substrate; and
a light emission unit positioned on the second substrate.

12. The electron emission display of claim 11, wherein the at least one sub-electrode is positioned in a groove on the first substrate.

13. The electron emission display of claim 11, wherein the first substrate comprises a transparent material and the cathode electrode comprises a transparent conductive material.

14. The electron emission display of claim 13, wherein the at least one sub-electrode is spaced from the at least one electron emission region.

15. The electron emission display of claim 14, wherein the at least one sub-electrode comprises a pair of sub-electrodes, and a corresponding one of the at least one electron emission region is located between the pair of sub-electrodes.

16. The electron emission display of claim 15, wherein the pair of sub-electrodes are symmetrically arranged with respect to the corresponding one of the at least one electron emission region.

17. The electron emission display of claim 14, wherein the at least one sub-electrode is adjacent the cathode electrode at only one side of the at least one electron emission region.

18. The electron emission display of claim 11, wherein a surface of the first substrate and a surface of the sub-electrode are coplanar.

19. The electron emission display of claim 11, further comprising:
a second insulation layer positioned on the gate electrode; and
a focusing electrode positioned on the second insulation layer.

20. The electron emission display of claim 11, wherein the at least one sub-electrode is comprises metal.
